(19) United States
(12) Patent Application Publication
(10) Pub. No.: US 2007/0035401 A1
(43) Pub. Date: Feb. 15, 2007

(54) METHOD AND SYSTEM FOR SECURING A TRANSPONDER TO AN OBJECT FOR PERFORMING CONTACTLESS TRANSACTIONS

(75) Inventor: Thomas R. Bartz, Lynden, WA (US)

Correspondence Address: LEE & HAYES, PLLC, 421 W. RIVERSIDE AVE, STE 500, SPOKANE, WA, 99201, US

(73) Assignee: ACCELITEC, INC., Bellingham, WA (US)

(21) Appl. No.: 11/464,697

(22) Filed: Aug. 15, 2006

Related U.S. Application Data
(60) Provisional application No. 60/708,895, filed on Aug. 15, 2005.

(51) Int. Cl. G08B 13/14

(52) U.S. Cl. 340/572.8

(57) ABSTRACT

A transponder securing apparatus includes a transponder holder configured to receive a transponder and a mechanism operably coupled with the transponder holder and configured to be attached to an object. The mechanism may include a wrappable mechanism having ends being configured to be wrapped around an object and secured to at least one of the object and another end. The mechanism may include a clamping mechanism including at least two openings configured to engage edges of the object. The mechanism may include an elastic mechanism configured to be elongated to fit around the object and to contract to secure the transponder securing apparatus to the object. The mechanism may include a locking mechanism having a first portion configured to extend through the object and a second portion configured to mechanically engage the first portion to hold the first portion and the second portion in place.

### RELATED APPLICATION

This application claims the priority of U.S. Provisional Patent Application Ser. No. 60/708,895, filed on Aug. 15, 2005. Priority is hereby claimed to this previously-filed application under 35 U.S.C. § 120.

### TECHNICAL FIELD

This invention relates to contactless transactions, and more particularly, to deploying a transponder for convenient carrying and access.

### BACKGROUND

With the passage of time, increasingly fewer consumers use cash or checks in retail transactions. Increasingly, consumers use credit cards, debit cards, and other contactless payment systems to make purchases of goods or services.

As these alternative forms of payment have become more popular, some institutions that provide credit cards and debits cards have attempted to make it easier for consumers to carry their cards. Some provide “mini-cards” that can be carried on a keychain, so that a consumer can complete a transaction without having to carry a wallet or otherwise carry a full-size card. Notwithstanding, consumers who use these mini-cards still have to carry their keys or otherwise carry the mini-cards in their pockets or purses.

Some institutions also have begun issuing contactless payment devices, such as radio frequency identification (“RIFD”) transponders that consumers can use to pay for transactions by waving the transponder over a reader, instead of swiping a magnetic stripe on a credit or debit card through a reader. The transponders offer many advantages. For example, transponders are not prone to wear out as are magnetic stripes. Also, transponders are more difficult to copy than magnetic stripes, and thus provide greater protection against fraud. Further, a transponder can store much more information than a magnetic stripe. Nonetheless, like mini-cards, conventional transponders generally are carried by attaching them to a key ring and, thus, must be carried by hand or in a purse or pocket.

### SUMMARY

A transponder securing apparatus includes a transponder holder configured to receive a transponder and a mechanism operably coupled with the transponder holder and configured to be attached to an object. The mechanism may include a wrappable mechanism having ends being configured to be wrapped around an object and secured to at least one of the object and another end. The mechanism may include a clamping mechanism including at least two openings configured to engage edges of the object. The mechanism may include an elastic mechanism configured to be elongated to fit around the object and to contract to secure the transponder securing apparatus to the object. The mechanism may include a locking mechanism having a first portion configured to extend through the object and a second portion configured to mechanically engage the first portion to hold the first portion and the second portion in place.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of three-digit reference numbers and the two left-most digits of four-digit reference numbers identify the figure in which the reference number first appears. The use of the same reference numbers in different figures indicates similar or identical items.

FIG. 1 is a perspective view of a transponder securing apparatus securing a transponder to a watchband of a wristwatch.

FIGS. 2-4 are perspective views of an implementation of a transponder securing apparatus being wrapped around the watchband of the wristwatch of FIG. 1 to secure the transponder band to the wristwatch.

FIG. 5 is perspective view of a transponder securing apparatus securing a transponder to a wristwatch band with an elastic strap extending around the watchband.

FIG. 6 is a perspective view of a transponder attached to a watchband with a transponder securing apparatus that includes rigid or semi-rigid bracket that extends at least partially around the edges of the watchband.

FIG. 7 is an exploded view of a transponder securing apparatus attachable to a wristwatch band by a securing apparatus configured to extend through the cross-section of the watchband securable by a receiving mechanism.

FIG. 8 is perspective view of the transponder securing apparatus of FIG. 7 securing a transponder to a wristwatch band.

FIG. 9 is a flow diagram of a process for preparing a transponder securing apparatus attachable to a watchband or other article.

### DETAILED DESCRIPTION

Overview

A transponder securing device secures a transponder, such as an RFID transponder to an article such as a watchband of a wristwatch, another form of wristband, or another portable article. In the example of a watchband, the transponder is secured using one of a number of exemplary transponder securing apparatuses. In the example of a watchband, a user can use the transponder to complete a transaction without separately carrying or reaching for a transponder. Instead, the user can use the transponder by passing his or her arm on which the watchband is worn within the range of a transponder reader. As a result, the transponder is transported with no additional effort than is used in putting on one's watch, and the transponder can be accessed without reaching into a pocket, purse, or other article.

As described below, the transponder is secured to the transponder securing apparatus with adhesives, sleeves, direct molding, or other objects or processes. The transponder securing apparatus secures the transponder to an article, such as a watchband, using adhesives, wrappable bands, elastic bands, a mechanical member secured by a receiving device, or other objects or processes. The following discussion focuses principally on transponder securing apparatuses configured to secure a transponder to a watchband of a wristwatch. Nonetheless, it should be appreciated that the transponder securing apparatus also may be used to secure a transponder to other articles that may be worn or carried by a user, so that the user may conveniently transport and make use of the transponder.

A Wrappable Transponder Securing Apparatus

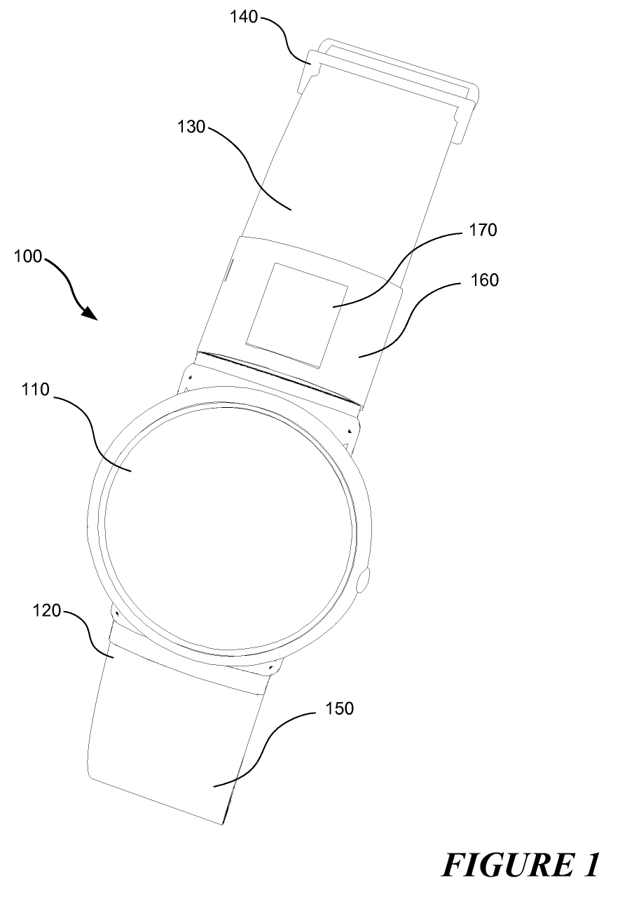

FIG. 1 illustrates an implementation of a transponder securing apparatus that secures a transponder to a wristwatch 100. The wristwatch 100 includes a watch face 110 and a watchband 120. The watchband 120 includes an upper end 130 that supports a buckle 140 that is used to receive and secure a lower end 150 of the watchband to strap the wristwatch 100 to a user's wrist. It is noted that there are many other types of watchbands that are secured to a user's wrist in other ways. For example, there are watchbands including upper and lower ends that are secured with hook-and-loop fasteners instead of a buckle 140. For further example, there are other solid or stretchable watchbands or other watchbands that, instead of including a separate upper end 130 and a separate lower end 150, include a continuous strap that extends between opposing ends of the watch face 110. Transponder securing apparatuses can be used to secure a transponder to these and other types of watchbands or other articles. Thus, the depiction of a wristwatch 100 including a watchband 120 that includes an upper end 130 and a lower end 150 joinable by a buckle 140 is only one example of the type of watchband 120 or other article to which a transponder may be secured.

A transponder securing apparatus 160 supports a transponder (not shown) in the example of FIG. 1 that is secured by a cover 170. The transponder is placed between the transponder securing apparatus 160 and the cover 170, and the cover 170 is joined at its edges to the transponder securing apparatus 160. The cover 170 is joined to the transponder securing apparatus 160 using adhesives, thermal welding, stitching, or objects and techniques to secure the cover 170 to the transponder securing apparatus 160, and thereby secure the transponder to the transponder securing apparatus 160.

One should note that the transponder can be joined to a transponder securing apparatus using any number of techniques, and fastening the transponder to the transponder securing apparatus 160 is not limited to securing the transponder to the transponder securing apparatus 160 with a cover 170. The transponder, for example, could be attached directly to the transponder securing apparatus 160 with an adhesive, or the transponder securing apparatus 160 could be molded around the transponder. Implementations of the transponder securing apparatus 160 are not limited to a particular form of attaching the transponder to the transponder securing apparatus 160.

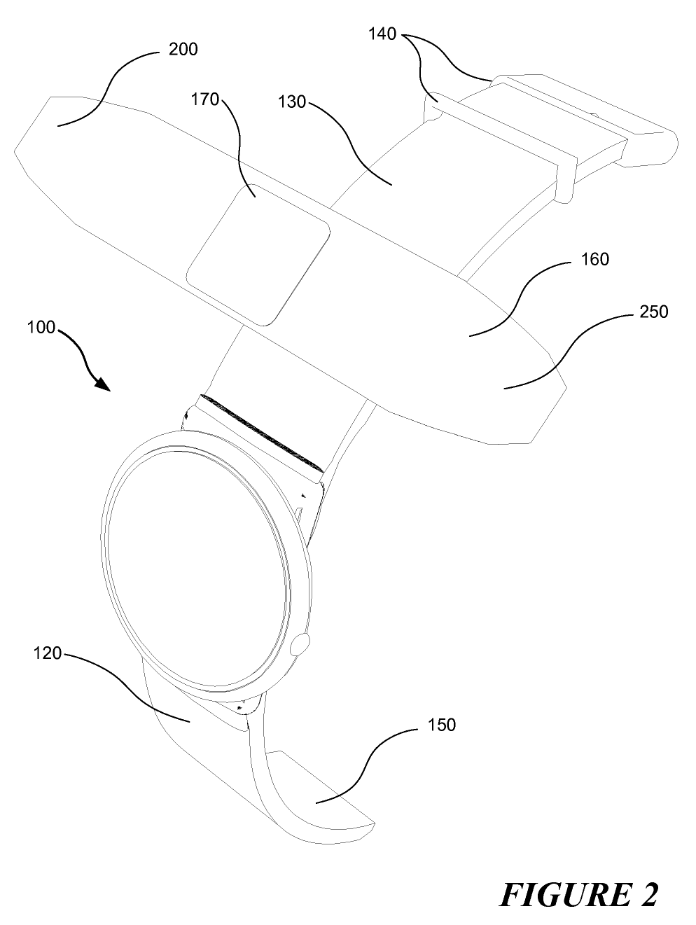

FIG. 1 shows a transponder securing apparatus 160 that is configured to be wrapped around either the upper end 130 or the lower end 150 of the watchband 120, preferably securing the transponder securing apparatus 160 to the watchband 120 without blocking or obscuring the watch face 110. Ends of the transponder securing apparatus 160 (not shown in FIG. 1) are joined with one another to secure the transponder securing apparatus 160 to the watchband 120, as is further described below with regard to FIGS. 2-4.

FIG. 2 illustrates the transponder securing apparatus 160 in its original form, before it is secured to the watchband 120. The transponder securing apparatus 160, with a transponder (not shown) secured to it by the cover 170, has a first end 200 and a second end 250. The transponder securing apparatus 160 is positioned to be secured about an upper end 130 of the watchband 120, as shown in FIG. 1. Nonetheless, one will appreciate that the transponder securing apparatus 160 could be attached to the lower end 150 of the watchband 120. For a watchband 120 having detachable ends 130 and 150, there may be an advantage in securing the transponder securing apparatus 160 to an end, such as the upper end 130, that supports the buckle 140. If the transponder securing apparatus 160 should slide along the watchband 120, the buckle 140 may prevent the transponder securing apparatus 160 from sliding off the watchband 120 when the wristwatch 100 is removed by the user. Nonetheless, an implementation as described with regard to FIGS. 1-4 is securable to any end or part of a watchband or other article.

At least one of the ends 200 and 250 in the implementation of FIGS. 1-4 includes a securing mechanism to secure the ends 200 and 250 to one another or to the watchband 120. For example, one surface of the first end 200 of the transponder securing apparatus 160 may include an adhesive configured to be secured to the second end 250 of the transponder securing apparatus 160. The adhesive may be activated by moistening or peeling off a backing. Alternatively, both ends 200 and 250 may include adhesives configured to be mated to one another, or to the surface of the watchband 120. In either case, when the adhesive is activated, the transponder securing apparatus 160 is wrapped around the watchband 120 and secured to the watchband 120.

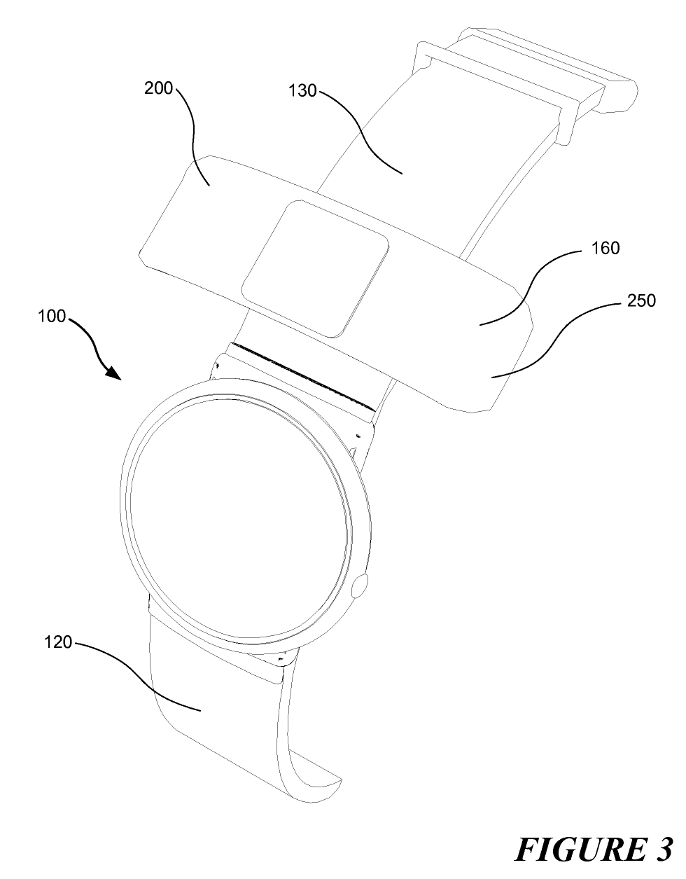

Continuing with the example of a transponder securing apparatus 160 secured by an adhesive, FIG. 3 shows a first view of the transponder securing apparatus 160 being secured to the wristwatch 100. FIG. 3 shows the transponder securing apparatus 160 beginning to be wrapped or curled around the upper end 130 of the watchband 120, with the ends 200 and 250 of the watchband starting to be curled toward one another. The adhesive may already have been activated, or the adhesive may be activated after the ends 200 and 250 are at least partially wrapped around the upper end 130 of the watchband 120.

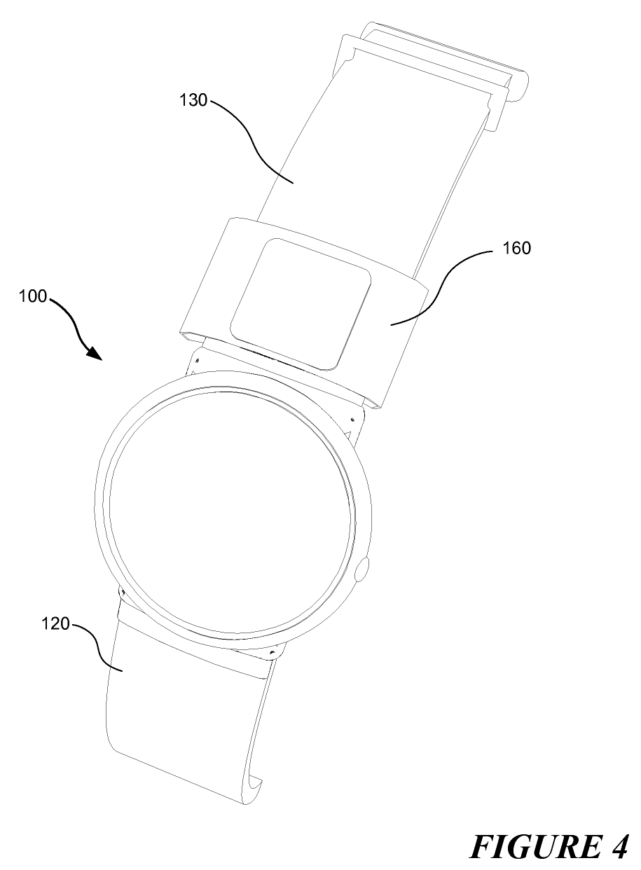

FIG. 4 illustrates further progress in securing the transponder securing apparatus 160 to the upper end of the watchband 120. The ends (not shown in FIG. 4 as they are wrapped behind the upper end 130 of the watchband 120) are curled almost entirely on top of one another. Completion of the securing of the transponder securing apparatus 160 is shown in FIG. 1, when the ends of the transponder securing apparatus 160 are joined with one another and/or with the watchband 120.

Using an adhesive to secure the transponder securing apparatus 160, the adhesive may be configured to be permanent, such that the transponder securing apparatus 160 is removable only by cutting the transponder securing apparatus 160 off the watchband. Alternatively, the adhesive may be removable and resecurable, such that a user can remove the transponder securing apparatus 160 (and the transponder it supports) from the watchband 120 to place it on another watchband, wristband or other article. As previously mentioned, the adhesive may be disposed to join the transponder securing apparatus 160 to the watchband 120 or other object by being configured for the ends to be attached to one another.

For example, what is designed to be an outer end of the transponder securing apparatus 160 may include an adhesive on an underside that will face the watchband 120 when deployed so as to join to the other end of the transponder securing apparatus 160 once each end is wrapped around the watchband 120 or another object. The opposing end may not include its own adhesive section, may include another adhesive surface or other material specially configured to be permanently or removably secured to the adhesive on the other end. Further alternatively, the transponder securing apparatus 160 may include adhesive multiple portions across its underside like a common disposable, adhesive bandage. In such an implementation, that the transponder securing apparatus 160 will both adhere to the watchband 120 and to itself, much the way an adhesive bandage adheres to a finger or other appendage. Any desirable form or placement of adhesive may be used in implementations of a transponder securing apparatus 160.

In addition to adhesives, ends of the transponder securing apparatus 160 may be coupled with one another using other types of fastening objects or techniques. For example, a hook-and-loop fastener may be used, in which one end of the transponder securing apparatus 160 includes a set of hook fasteners on an outward facing surface, while the opposing end of the transponder securing apparatus 160 includes a set of loop closures on an inward facing surface, or vice versa. In this arrangement, the transponder securing apparatus 160 is solidly but removably attachable to the watchband 120 by wrapping the transponder securing apparatus 160 around the watchband and pressing the hook and loop surfaces together. Similar, paired types of fasteners also may be used in which each pair of the fastener is disposed at an opposing end of the transponder securing apparatus 160. Such paired fasteners may include a button and buttonhole pair, a snap mechanism with a protruding member and a receiving member, a single hook and single loop pair, or any other form of mating connectors.

An Elastic Transponder Securing Apparatus

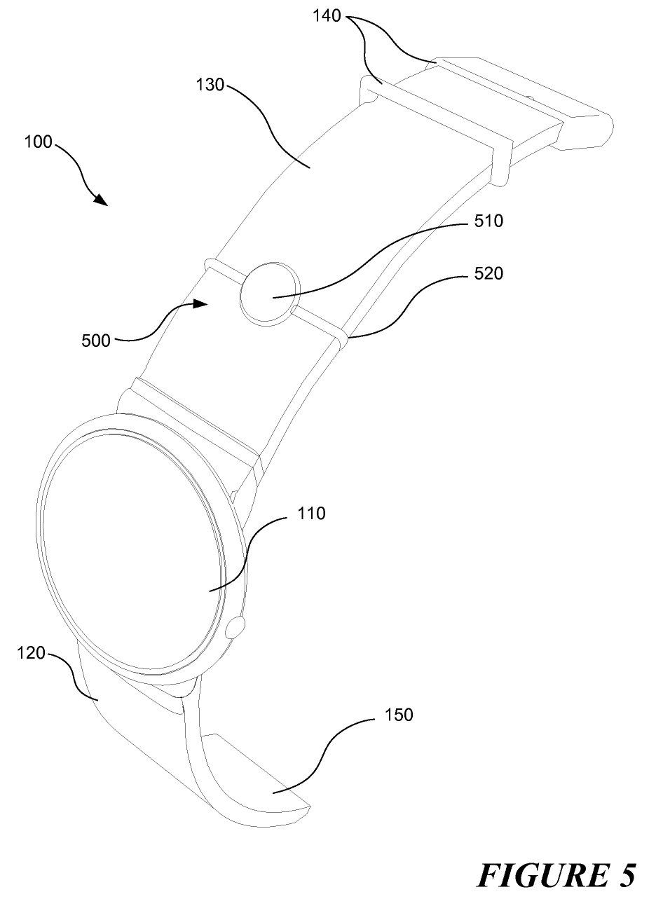

FIG. 5 depicts another implementation of a transponder securing apparatus 500 used to secure a transponder to an object, such as the watchband 120 of a wristwatch 100. The transponder securing apparatus 500 of FIG. 5 includes a transponder holder 510 coupled with a stretchable, elastic band 520 used to secure the transponder (not shown) to a watchband 120 or other object.

The transponder holder 510, as well as the elastic band 520, may be molded around the transponder. Alternatively, the transponder holder 510 and the elastic band 520 may be molded in a single step, with a transponder being affixed to the transponder holder 510 with an adhesive. Further alternatively, the transponder may be secured to the transponder holder 510 with a cover that is joined to the transponder holder 510 around its edges, as previously described with regard to the implementation illustrated in FIGS. 1-4. Also alternatively, the elastic band 520 may be formed as a single, continuous band that is adhered to or otherwise passed through the transponder holder 510. In addition, the elastic band 520 may be formed separately from the transponder holder 510 and joined to the transponder holder 510 using any number of techniques, such as welding, adhesives, tying, or other techniques.

The transponder securing apparatus 500 is shown secured to the upper end 130 of the watchband 120. To secure the transponder securing apparatus 500, the elastic band 520 of the transponder securing apparatus 500 is stretched to an elongated position large enough to slip over the buckle 140 of the watchband 120. The transponder securing apparatus 500 is then moved to a desired position around the watchband 120, and then the elastic band 520 is released to allow the transponder securing apparatus 500 to return to a less elongated condition, securing itself into place around the watchband 120. In the case of transponder securing apparatus 500, the transponder securing apparatus 500 may be secured to the lower end 150 of the watchband 120. However, securing the transponder securing apparatus 500 to the upper end presents an advantage in that, if the transponder securing apparatus 500 were to slip along the length of the upper end 130 of the watchband 120 away from the watch face 110, the buckle 140 might prevent the transponder securing apparatus 500 from unintentionally slipping off of the watchband 120 entirely.

Using an elastic transponder securing apparatus 500, the transponder securing apparatus 500 could be removably attached to a watchband 120 or another object. The removable attachment, using an elastic transponder securing apparatus 500 or another type of removable transponder securing apparatus, would allow the transponder securing apparatus 500 to be moved between different wristwatches or other objects a user might carry to permit convenient transportation of and access to the transponder.

A Rigid or Semi-Rigid Transponder Securing Apparatus

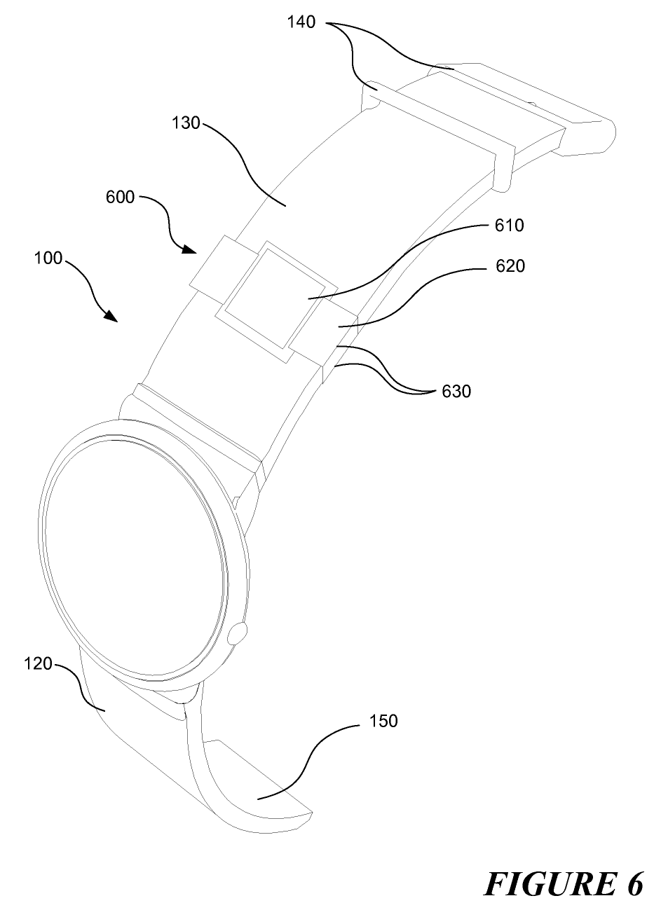

FIG. 6 depicts another form of transponder securing apparatus 600 configured to be clamped to the watchband 120 of a wristwatch 100 or another object. The transponder securing apparatus 600 includes a transponder holder 610, to which the transponder (not shown) is attached, into which the transponder is inserted, or is molded or formed about the transponder. Secured to the transponder holder 610, or integrally formed with the transponder holder 610, is a clamping apparatus 620 that is rigid or semi-rigid in nature. In one implementation, the clamping apparatus 620 is formed of a strip of material that can be bent to form edges 630 that conform to edges of the watchband 120 to hold the transponder securing apparatus 600 securely in place. The clamping apparatus 620 may be long enough to wrap at least completely around the watchband 120, or the clamping apparatus 620 may be long enough to extend just around the edges of the watchband 120 to secure the transponder securing apparatus 600 to the watchband 120. Alternatively, the clamping apparatus 620 may preformed with hook-shaped end pieces configured to engage the edges of the watchband 120. In such an implementation, the clamping apparatus 620 may be deformed slightly to allow the hook-shaped end pieces to be clipped around the edges of the watchband 120. The clamping apparatus 620 then would be permitted to return toward its original shape while securely engaging the edges of the watchband 120.

As in FIGS. 1-5, the transponder securing apparatus 600 is secured to an upper end 130 of the watchband 120, so that if the transponder securing apparatus 600 slips along the watchband 120 toward the buckle 140, the buckle may prevent the transponder securing apparatus 600 from slipping completely off the upper end 130 of the watchband 120. Nonetheless, the transponder securing apparatus 600 could be secured to either the upper end 130 or the lower end 150 of the watchband 120.

A Locking Type Securing Apparatus

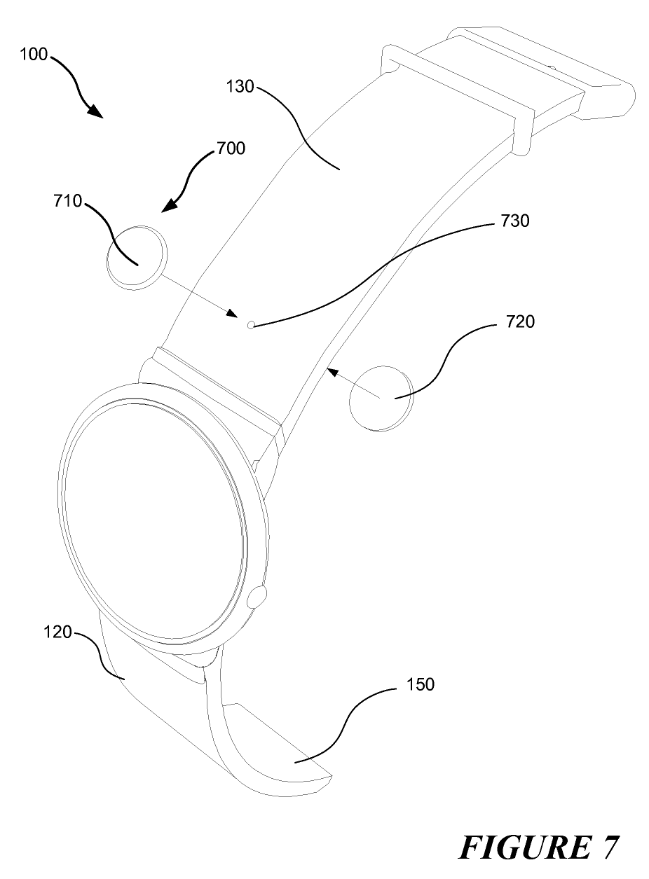

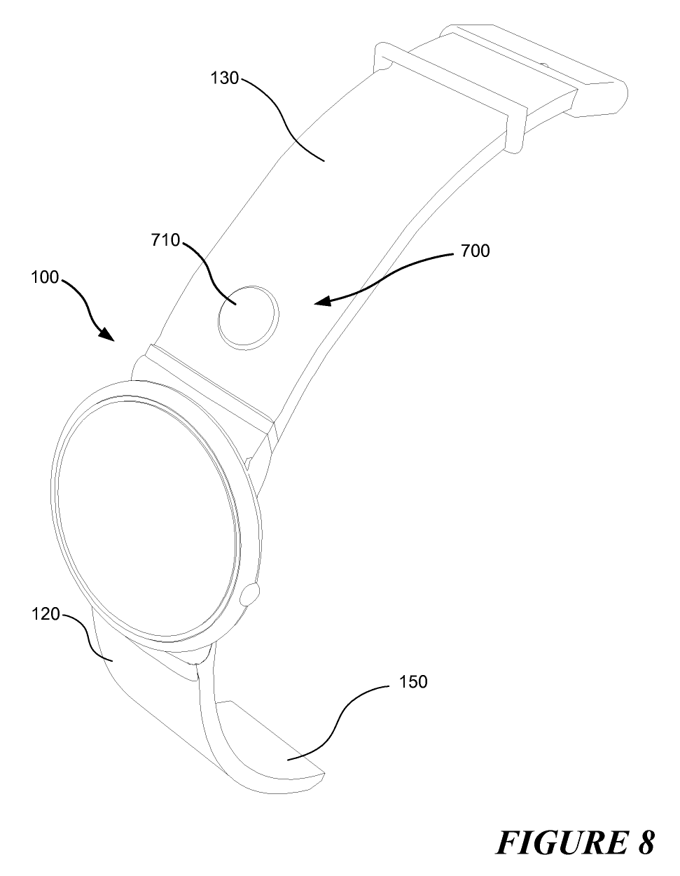

FIGS. 7 and 8 illustrate a locking-type of transponder securing apparatus 700 for attaching a transponder (not shown) to a watchband or other object. This form of transponder securing apparatus 700 includes two parts: a transponder holder 710, supporting a connecting member, and an engaging member 720 that are disposed on opposing surfaces of a watchband 120 or other object. A locking implementation of a transponder securing apparatus 700 may include a structure like that used in snaps or on tie-tacks or other jewelry. More specifically, one of the connecting member of the transponder holder 710 or the engaging member includes an extending member configured to extend through an opening 730 formed in a watchband 120 or other object. The opening 730 may include a pre-existing opening, or a specially-made hole in that object.

Once the extending member passes through the watchband 120 or other object, the opposing section of the transponder securing apparatus 700 receives the extending member to hold the parts of the transponder securing apparatus 700 in place using mechanical force. In other words, the transponder holder 710 may include a male, extending member, and the engaging member 720 may include a female, receiving member to mechanically engage the extending member. Alternatively, the engaging member 720 may include a male, extending member configured to extend through the opening 730, and the transponder holder 710 may include a female, receiving member to mechanically engage the extending member.

FIG. 8 shows the locking-type of transponder securing apparatus 700 installed on an upper end 130 of the watchband. Because the transponder securing apparatus 700 is secured through the thickness of the watchband, there is no strap or other member extending around the edges of the watchband 120. In addition, because the transponder securing apparatus 700 is attached through the thickness of the watchband 120, it will be appreciated that there is no advantage to installing the transponder securing apparatus 700 on the upper end or the lower end 150 of the watchband 120.

As in other implementations, the transponder is attachable to the transponder holder 710 with an adhesive, or is otherwise encompassed or inserted within the transponder holder. The male, extending member may be the flanged tip of a male end of a snap, and the female, engaging member 720 may include the female end of a snap. Alternatively, the extending member may include a pin or other piercing device that is frictionably engaged by a female engaging member.

In addition, as shown in FIG. 8, a one-sided transponder holder could be adhesively or otherwise coupled to a surface of the watchband 120, without an engaging member on an opposite side of the watchband 120. Further alternatively, the transponder could be integrated into the watchband 120 itself. Thus, instead of attaching the transponder securing apparatus to an existing watchband 120, the transponder could be affixed to a wristwatch 100 by removing the existing watchband and replacing the watchband with a band into which a transponder is molded or to which the transponder is otherwise permanently secured.

It should be noted that different types of transponder securing apparatuses as previously described each may be better suited for some applications than others. For example, for a continuous watchband that does not have loose ends that are joined together, either the wrappable type or clamping type of transponder securing apparatus are desirable, because there is no open or loose end over which an elastic type of transponder securing apparatus could be disposed. Correspondingly, a clamping type of transponder securing apparatus may not be as desirable for a soft leather, cloth, or plastic watchband, while either a wrappable type or an elastic type of watchband may be more suitable. A locking-type of transponder securing apparatus may not be suitable for a metal watchband, but may be ideal for a plastic or leather band. Different forms of transponder securing apparatuses can be used for different types of applications.

Also, a transponder securing apparatus can also be attached to other objects using any of the exemplary forms of transponder securing apparatuses described. Transponder securing apparatuses can be attached to other wearable objects, such as wrist bands or bracelets. By way of further example, a transponder securing apparatus could be worn as a ring around a finger or wrapped around another object that one might carry in a pocket. In addition, a transponder securing apparatus could be secured to a strap on a purse, briefcase, or other bag that a person regularly carries, presenting the transponder on an easily accessible portion of the bag for convenient access. Similarly, a locking-type type transponder securing apparatus could be affixed to clothing, an eyeglass case, or another object.

Process of Preparing a Transponder Securing Apparatus

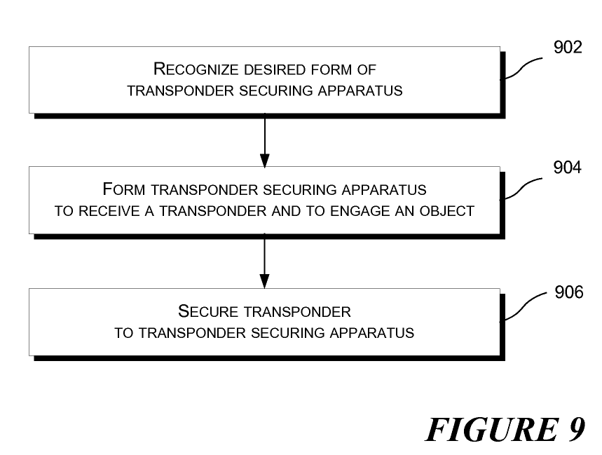

FIG. 9 illustrates one exemplary process of preparing a transponder securing apparatus to be provided to a user for presenting a transponder. At 902, the form of transponder securing apparatus is recognized, whether the form includes a wrappable type, a clamping type, a locking type, or another form. At 904, the transponder securing apparatus is formed to be able to receive a transponder and to engage an object to which the transponder securing apparatus will be engaged. At 906, if the transponder securing apparatus was not integrally formed with the transponder, the transponder is secured to the transponder securing apparatus.

### CONCLUSION

Although exemplary embodiments have been described in language specific to structural features and/or methodological acts, it is to be understood that the appended claims are not necessarily limited to the specific features or acts previously described. Rather, the specific features and acts are disclosed as exemplary embodiments.

1. A transponder securing apparatus for securing a transponder to an object, comprising:
a transponder holder; and
a mechanism operably coupled with the transponder holder and configured to be attached to an object, the mechanism including at least one of:
a wrappable mechanism having at least two ends, each of the ends being configured to be wrapped around an object and secured to at least one of the object and an other end;
a clamping mechanism including at least two openings configured to engage edges of the object;
an elastic mechanism configured to be elongated to fit around the object and to contract to secure the transponder securing apparatus to the object;
a locking mechanism having a first portion configured to extend through the object and a second portion configured to mechanically engage the first portion to hold the first portion and the second portion in place.
